(19) United States
(12) Patent Application Publication
(10) Pub. No.: US 2026/0288431 A1
(43) Pub. Date: Sep. 24, 2026

(54) SYSTEM AND METHOD FOR EXTRACTING AND DISPLAYING A SIMPLIFIED CONDITION FLOW GRAPH SHOWING THE CONDITIONS LEADING TO THE EXECUTION OF BUSINESS RULES

(71) Applicant: HATHA SYSTEMS, LLC, Washington, DC (US)

(72) Inventors: Mike Oara, Washington, DC (US); Mikhail BULYONKOV, Novosibirsk (RU); Rama S. MOORTHY, Washington, DC (US)

(21) Appl. No.: 19/575,374

(22) Filed: Mar. 23, 2026

Related U.S. Application Data
(60) Provisional application No. 63/775,645, filed on Mar. 21, 2025.

(51) Int. Cl. G06F 8/41; G06N 5/022; G06Q 10/067

(52) U.S. Cl. CPC G06F 8/433; G06F 8/427; G06N 5/022; G06Q 10/067

(57) ABSTRACT

A system for generating a condition flow graph from a control flow graph associated with a software application. The system receives source code and generates a control flow graph including nodes representing program elements and edges representing execution paths. The system identifies nodes corresponding to business rules within the control flow graph and generates the condition flow graph by reducing the control flow graph. The reduction process includes retaining selected node types, including entry point nodes, conditional nodes, and business rule nodes, while removing nodes not belonging to the selected types. For removed nodes, incoming and outgoing edges are merged to form direct connections between remaining nodes. The resulting condition flow graph provides a simplified representation of execution paths relevant to business rules. The system may further present the condition flow graph to a user for analysis and visualization.

### RELATED APPLICATIONS

The present application claims priority to U.S. provisional patent application Ser. No. 63/775,645, filed on Mar. 21, 2025, and entitled SYSTEM AND METHOD FOR EXTRACTING AND DISPLAYING A SIMPLIFIED CONTROL FLOW GRAPH SHOWING THE CONDITIONS LEADING TO THE EXECUTION OF BUSINESS RULES, the contents of which is herein incorporated by reference.

### BACKGROUND OF THE INVENTION

The present invention is related to the creation of a control flow graph, and is specifically related to the creation of a control flow graph that is associated with the execution of business rules in a software application.

As is known in the art, a control flow graph can be used to represent a flow of control within software code associated with a software application. The control flow graph can show or illustrate the order in which different parts of the application are executed by an electronic device, such as a computing system. A typical control flow graph can include nodes and edges. For example, the control flow graph can include an entry node which corresponds to the starting point of the graph and represents the beginning of a software program and an exit node which corresponds to the endpoint of the graph and represents the termination of the software program. The control flow graph can also include intermediate nodes (e.g., basic blocks) that include sequences of instructions without internal branches. Each basic block can be executed sequentially from start to end. The control flow graph also includes control flow edges representing control flow paths connecting the nodes and basic blocks, showing the possible transitions within the software application based on conditions (e.g., if-else statements, loops, and the like). The control flow graph can highlight decision points, loops, and branches in the software code.

The control flow graph is typically used in compiler design and static analysis to optimize software code and to detect potential errors. The control flow graph can help a user understand the logic and flow of a software program, identifying unreachable code, and optimizing control paths within the software code.

The conventional control flow graphs have certain disadvantages. The control flow graphs can take time to manually create and are labor-intensive, especially for large and complex programs. The manual construction of the control flow graphs are susceptible to human errors, such as missing edges or incorrect connections, leading to inaccurate representations of the program's control flow. To address these issues, the prior art developed static analysis tools. The static analysis tool is typically a software utility that analyzes source or compiled code of a software program without actually executing it. The primary goal of the static analysis tools is to find potential errors, vulnerabilities, and compliance issues early in the software development process. However, the static analysis tools also suffer from drawbacks. Conventional static analysis tools struggle with handling highly complex or dynamically typed languages, leading to incomplete or incorrect control flow graphs. Further, many tools do not adequately handle different contexts or function calls, which can result in oversimplified graphs that miss important control flows.

While the control flow graphs can be powerful tools for understanding and optimizing program control flow, the generation and maintenance of the graphs pose significant challenges. Traditional methods of creating the control flow graphs can be laborious and inaccurate, and the graphs can become complex and difficult to manage for large or dynamically evolving programs.

### SUMMARY OF THE INVENTION

The present invention is directed to a control path generation system and associated method for identifying business rules and conditions implementing the business rules in the source code of a software application. The control path generation system of the present invention can be configured to generate a control flow diagram in which nodes in the diagram represent the conditions in a program, and where the execution is illustrated as branches, and the edges between the nodes indicate which paths are taken (e.g., “true” or “false”). Once the diagram is generated and displayed, a user of the system can see which are the execution paths leading to the execution of the business rule and which are the conditions which need to be fulfilled.

The present invention relates to systems and methods for analyzing software applications and, more particularly, to a control path generation system and associated method for identifying business rules within source code, generating a control flow graph that includes the business rules and condition for executing the business rule, and then generating a simplified representations of the execution paths that illustrate the conditions under which the business rules are executed in the form of a condition flow graph. The control path generation system can be configured to analyze the source code and generate a control flow graph representing execution paths within the software application. The control path generation system can include a code analysis unit configured to process the source code and generate a structured representation thereof and a control flow graphing unit configured to generate a control flow graph based on the structured representations. The control flow graph can include nodes representing program elements, such as entry points, conditional statements, program calls, and the business rules, and edges representing transitions between the program elements based on execution flow.

The control path generation system can further include a business rule identification unit configured to identify business rules within the source code and provide corresponding business rule data for incorporation into the control flow graph. In alternative embodiments, the business rule identification can be performed by the code analysis unit and/or the control flow graphing unit, such that identification of business rules and generation of the control flow graph can be performed in a distributed or more integrated manner. The control path generation system can thus support modular, integrated, or hybrid implementations of business rule identification and control flow analysis.

The control path generation system can also include a control process flow unit that can be configured to process the control flow graph with business rules and then generate in response a reduced representation of the control flow graph, referred to as a condition flow graph. The control process flow unit can selectively eliminate nodes that are not relevant to determining the conditions under which a business rule is executed. In conjunction with the node elimination, the control process flow unit can be configured to merge or reconnect edges to preserve execution paths between the remaining nodes in the graph, thereby maintaining logical relationships while reducing graph complexity. The resulting condition flow graph can include only selected nodes belonging to a selected set of node types, including for example entry point nodes, conditional nodes associated with execution of the business rule, and nodes representing the business rules. By focusing on a selected set of node types, the condition flow graph provides a simplified and human-readable representation of the execution paths that define the conditions under which a business rule is invoked by the software application or program. The condition flow graph is hence a reduced graphical representation that enables improved understanding, analysis, and validation of the business rule logic within a computing system.

The control path generation system can also include a user interface generator configured to generate one or more user interfaces for presenting the control flow graph and/or the condition flow graph to a user. The user interface can provide visualization of execution paths and support user interaction, such as selecting, filtering, or annotating nodes and edges, thereby facilitating exploration and analysis of business rule execution conditions. Accordingly, the control path generation system of the present invention provides a technical solution for transforming complex program control flow into a simplified conditional representation that highlights the execution context of business rules. This approach improves the efficiency and accuracy of business rule analysis and provides a scalable mechanism for understanding rule behavior within large and complex software applications.

The present invention is directed to a system for generating a condition flow graph from a control flow graph having one or more business rules within a software application. The system includes one or more processors and one or more non-transitory computer-readable media storing instructions that, when executed by the one or more processors, cause the system to receive source code of a software application; generate, from the source code, a control flow graph having a plurality of nodes and a plurality of edges, wherein each of the plurality of nodes represents a program element of the source code and each edge of the plurality of edges represents an execution path between the plurality of nodes; identify, within the control flow graph, one or more of the plurality of nodes corresponding to the business rules to form business rule nodes implemented within the source code; and generate the condition flow graph from the control flow graph by reducing the control flow graph. The graph reduction includes retaining selected ones of the plurality of nodes belonging to a selected set of node types including entry point nodes, conditional nodes, and the business rule nodes; removing one or more nodes from the control flow graph not belonging to the selected set of node types; and for each removed node, merging incoming and outgoing edges associated with the removed node to form one or more direct edges between remaining nodes. The system also includes displaying the condition flow graph to a user.

The system is also configured to analyze the source code using a code analysis unit to generate code analysis data having a structured representation of the source code, and generate using a control flow graphing unit the control flow graph from the code analysis data. The structured representation comprises a parse tree or an abstract syntax tree. In the system of the present invention, the identifying the one or more of the plurality of nodes corresponding to the business rules comprises analyzing the source code to identify code snippets implementing business rule logic, and representing each identified business rule as business rule node within the control flow graph. The conditional nodes represent conditional constructs within the source code comprising at least one of an IF statement, a CASE statement, a WHILE loop, and a FOR loop, and wherein each conditional node includes multiple outgoing directed edges corresponding to alternative execution paths based on an evaluation outcome of the conditional construct. The nodes of the control flow graph can also include any combination of program call nodes representing calls to methods, functions, programs, instructions, statements, or paragraphs within the software application.

Further, in the application, the system can be configured to remove nodes not belonging to the selected set of node types until the condition flow graph includes only nodes of the selected set of node types. The condition flow graph represents execution paths from at least one entry point node to a plurality of business rule nodes, and wherein each execution path through the condition flow graph defines a sequence of conditional evaluations to be satisfied for a corresponding business rule to be executed. The system can also extract, from the source code, programmatic elements including at least one of data elements, statements, definitions, operations, code snippets, software artifacts, and relationships associated with the source code; and store the extracted programmatic elements in a knowledge repository.

In other embodiments, the system of the present invention can be configured for generating a condition flow graph from a control flow graph in a computing system. The system includes a data extraction unit for extracting source code from a software application, a business rule identification unit for identifying one or more business rules in the source code, and a code analysis unit for processing the source code and to convert the source code into a structured representation of the source code to form code analysis data. The system further includes a control flow graphing unit for processing at least one of the code analysis data and the business rules to form the control flow graph having a plurality of nodes representing a program element of the source code and a plurality of edges representing an execution path between the plurality of nodes. The plurality of nodes can include business rule nodes indicative of the business rules, conditional nodes indicative of the one or more conditions leading to execution of the business rule, and entry point nodes. The control flow graphing unit can be configured for generating control flow graphing data that includes the control flow graph. The system further includes a control process flow unit for receiving and processing the control flow graphing data and for generating from the control flow graph the condition flow graph. The control process flow unit is configured to generate the condition flow graph by reducing the control flow graph by retaining selected ones of the plurality of nodes belonging to a selected set of node types including the entry point nodes, the conditional nodes, and the business rule nodes; removing nodes from the control flow graph not belonging to the selected set of node types; and for each removed node, merging incoming and outgoing edges associated with the removed node to form one or more direct edges between remaining nodes. The structured representation includes at least one of a parse tree and an abstract syntax tree, and the business rule identification unit is configured to identify the business rules by analyzing the source code to identify code snippets implementing the business rule.

The present invention is also directed to a computer-implemented method for generating a condition flow graph from a control flow graph having one or more business rules within a software application. The method includes receiving, by one or more processors, source code of a software application; generating, by the one or more processors, a control flow graph from the source code having a plurality of nodes and a plurality of edges, wherein each of the plurality of nodes represents a program element of the source code and each edge of the plurality of edges represents an execution path between the plurality of nodes; identifying, by the one or more processors, within the control flow graph, one or more of the plurality of nodes corresponding to the business rules to form business rule nodes implemented within the source code; and generating, by the one or more processors, the condition flow graph from the control flow graph. The control flow graph is reduced by retaining from the control flow graph selected ones of the plurality of nodes belonging to a selected set of node types including entry point nodes, conditional nodes, and the business rule nodes; removing one or more nodes from the control flow graph not belonging to the selected set of node types; and for each removed node, merging incoming and outgoing edges associated with the removed node to form one or more direct edges between remaining nodes. The method also includes displaying the condition flow graph to a user.

The method includes analyzing the source code to generate code analysis data having a structured representation of the source code, and generating the control flow graph from the code analysis data, and the structured representation includes a parse tree or an abstract syntax tree. The method also includes identifying the one or more of the plurality of nodes corresponding to the business rules by analyzing the source code to identify code snippets implementing business rule logic, and representing each identified business rule as business rule node within the control flow graph. Still further, the method includes removing nodes not belonging to the selected set of node types until the condition flow graph includes only nodes of the selected set of node types.

The method also includes, in the control flow graph, representing execution paths from at least one entry point node to a plurality of business rule nodes, and in the execution paths, defining a sequence of conditional evaluations to be satisfied for a corresponding business rule to be executed.

The present invention also includes a non-transitory computer-readable medium for storing instructions that, when executed by one or more processors, cause the one or more processors to perform operations, comprising receiving source code of a software application; analyzing the source code to generate code analysis data comprising a structured representation of the source code; generating, from the code analysis data, a control flow graph comprising a plurality of nodes and a plurality of edges, wherein the plurality of nodes represent program elements of the source code and the plurality of edges represent execution paths between the plurality of nodes; identifying, within the control flow graph, business rule nodes from the plurality of nodes corresponding to business rules implemented in the source code; and generating a condition flow graph from the control flow graph. The condition flow graph is generated by retaining nodes of the plurality of nodes belonging to a selected set of node types including at least entry point nodes, conditional nodes, and the business rule nodes; removing from the control flow graph nodes not belonging to the selected set of node types; and for each removed node, reconnecting incoming and outgoing edges of the removed node as one or more direct edges between adjacent remaining nodes. The method also includes causing display of the condition flow graph.

The structured representation of the source code includes at least one of a parse tree and an abstract syntax tree, and the operations can further include extracting, from the source code, programmatic elements comprising at least one of code snippets, data elements, conditional constructs, and relationships among program components; and identifying the business rules based on patterns within the extracted programmatic elements. The operations can further include causing display of the control flow graph, and wherein a generated user interface enables a user to selectively switch between displaying the control flow graph and the condition flow graph.

### BRIEF DESCRIPTION OF THE DRAWINGS

These and other features and advantages of the present invention will be more fully understood by reference to the following detailed description in conjunction with the attached drawings in which like reference numerals refer to like elements throughout the different views. The drawings illustrate principals of the invention.

FIG. 1 is a schematic block diagram of a control path generation system according to the teachings of the present invention.

FIG. 2 is a schematic block diagram of a control flow graph generated by the control flow graphing unit of the control path generation system of FIG. 1 according to the teachings of the present invention.

FIG. 3 is a schematic block diagram of a condition flow graph generated by the control process flow unit from the control flow graph of FIG. 2 according to the teachings of the present invention.

FIG. 4 is another example of a control flow graph generated by the control flow graphing unit of the control path generation system of FIG. 1 according to the teachings of the present invention.

FIG. 5 is another example of a condition flow graph generated by the control process flow unit from the control flow graph of FIG. 4 according to the teachings of the present invention.

FIG. 6 is a schematic diagram of an electronic device and/or associated system suitable for implementing the process flow identification system of the present invention.

### DETAILED DESCRIPTION

The term “user” or “end user” is used to refer to a user or operator of the software application or associated computer system. The user can include an end user, a system administrator, a software developer, an analyst, and the like.

The term “software artifact” or “technical artifact” is intended to include an object which plays a role in the architecture and the running of a software application, such as a user interface (e.g., a screen or a window), a program or a data store. Software artifacts are defined by the developers of the software application such that, at runtime, the artifacts combine to support the functionality of the application. In different types of technologies, the program may also be called functions, procedures, or methods.

The term “data store” as used herein is intended to include any physical or logical device which holds or stores data, including data processed by the software application. The data stores can include tables, records, segments, indexed or sequential files, and the like.

The term “user interface” as used herein refers to any software artifact in a software application, which is used to present data to an operator or end user or acquire data from an operator or end user. The user interfaces can include screens, windows, panes, forms, pages or reports.

The term “program” as used herein refers to a discrete set or sequence of computer-executable instructions that are stored in a non-transitory medium and that, when executed by one or more processors, perform a specific task or function. A program may be embodied in human-readable form (e.g., source code), intermediate form (e.g., bytecode), or machine-executable form (e.g., object code or executable code). The program may include one or more modules, routines, procedures, classes, methods, scripts, or other code constructs, and is generally directed to a defined functional objective within a larger system. A program may operate independently or may be invoked by, or invoke, other programs.

The term “application” or “software application” as used herein refers to a broader software system forming part of a computing system that includes a plurality of programs and associated software artifacts that collectively provide integrated functionality for use by an end user, organization, or other system. A software application may include, for example, multiple executable programs, libraries, services, application programming interfaces (APIs), configuration files, database schemas, stored procedures, user interface components, and other related software artifacts that cooperate to implement business processes or operational workflows. The programs within a software application may communicate with one another through procedural calls, service interfaces, messaging mechanisms, shared data stores, or other communication techniques. Accordingly, a software application encompasses an organized aggregation of interrelated programs and supporting components, whereas a program represents a discrete executable unit within such an application. The application can have associated source code which can be programmatically called or can programmatically call other such procedural calls or that can communicate with a software artifact.

The term “application model” as used herein is intended to mean or include a data model consisting of entities, relationships and their associated attributes, collected through an extraction process (e.g., a reverse engineering process) and stored in selected memory or storage (e.g., files or a database). The entities can include programs, classes, statements, data elements, tables, columns, or screens. The attributes can include for example any associated identifying information, such as name, size, identification (ID) or kind that can further specify each entity. The entities may be related through relationships such as statement read fields, program update tables, program calls, and the like.

The term “code snippet,” “snippet of code,” or “snippets of code” as used herein refers to a contiguous set of statements, instructions, or lines of source code within a program or software application that collectively implement a particular portion of logic. A code snippet may include, for example, a conditional construct (such as an IF statement together with associated THEN and ELSE branches), a loop construct (such as a WHILE or FOR statement), a sequence of assignment or computational statements, a method body, or any other contiguous fragment of executable logic. A code snippet is a concrete portion of source code as written in a programming language and is distinct from “code syntax,” which refers to the grammatical or structural rules of a programming language that govern how statements must be formed. Thus, while a code snippet is expressed using the syntax of a particular programming language, the term “code snippet” refers to the substantive fragment of logic embodied in contiguous code, independent of the specific syntactic form or language in which that fragment is written.

As used herein, the term “control flow graph” is intended to mean or to refer to a graphical representation, such as a graph, of the paths that can be traversed through a program or software application during execution. The graphical representation can be used to depict the flow of control from one part of the program or application to another part of the program or application, thus illustrating a sequence in which instructions or statements are executed. The graph can include nodes and edges, where each node corresponds to a basic block of code with an entry and exit point and each edge represents a possible control transfer between the nodes, and edges can be formed between the nodes to indicate the flow of control from one node to another. For example, in conditional statements, the edges represent the paths taken based on whether the condition evaluates to true or false. In loops, the edges illustrate the repetition of the block until the loop's exit condition is met. The graph can include program call nodes representing calls to methods, functions, programs, instructions, statements, or paragraphs within the software application. A statement generally refers to an individual executable instruction within a program, whereas a paragraph refers to a collection of statements grouped under a common identifier and representing a logical program unit, as found in certain programming languages.

The term “business rule” as used herein refers to or means a predefined policy, constraint, condition, computation, decision logic, or operational directive that governs how data is validated, computed, derived, restricted, authorized, processed, or otherwise treated within a software application in order to conduct or support a business. A business rule may define, for example, a required condition (e.g., a customer must be at least 18 years old), a computational relationship (e.g., charge=price-discount+tax), a constraint (e.g., a loan cannot be approved if a credit score is below a threshold), a structural or domain limitation, a trigger based on an event, an authorization requirement, a workflow condition, or a temporal restriction. Business rules are generally conceptual or abstract in nature in that they reflect business policies or requirements independent of any particular software implementation. However, within a software application, such rules are typically embodied, enforced, or executed through one or more fragments or snippets of source code, configuration elements, database procedures, or other executable logic. A single abstract business rule may be implemented one or more times within the same application or across multiple applications, whether through reuse of shared code, invocation of common services, or duplication of similar logic in different components. A business rule is therefore distinct from the specific code that implements it, and not all source code constitutes a business rule, as certain code may relate solely to technical or presentation functions without embodying a business policy or decision. A business rule discovery process involves identifying the associated business rule, but also the implementation of the rule in the source code. The same abstract rule may be implemented multiple times in the code of an application, either by reuse of the same code via programmatic calls, or by simple duplication or replication of the code.

In modern computing systems, organizations frequently implement and enforce business policies, operational constraints, and decision logic through software applications that support or automate business processes. These policies and decision mechanisms (e.g., business rules) define how an organization conducts its operations and makes determinations in the course of executing business functions. The business rules may take many forms. For example, computation rules may define how values such as fees, taxes, or interest are calculated; validation rules may specify constraints on permissible data, such as requiring that a client be a resident of a particular jurisdiction; and domain rules may define classifications or categories applicable to business entities or transactions. In modern enterprise systems, such business rules are frequently embedded directly in the source code of the software application. While the same rules may also be described in documentation, policy manuals, or design specifications, the original source code of the application typically represents the most reliable and authoritative representation of the rules as they are actually executed by the system.

Understanding the business rules implemented within the software applications requires not only identifying the business rules via the business rule logic, but also understanding the context in which the business rule is executed. The context can include, for example, the sequence of programmatic steps through which execution reaches the rule and the conditions that are satisfied before the rule is reached and triggered. The contextual factors can be represented in the conditional structures and control flow of the application code. Accordingly, analysis of the conditions that lead to execution of the business rule helps understand how the business rule operates within the software application. The control path generation system of the present invention is directed in particular to identifying and presenting the conditional context that leads to execution of the business rules within software.

In software systems, the conditions that trigger execution of a business rule can be determined by analyzing the source code in which the rule is implemented. Conventional approaches can rely on manual code inspection or on the generation of control flow graphs that represent the sequence and branching of operations within a program or software application. A control flow graph represents program execution as a set of nodes corresponding to program actions, such as computations, assignments, data movements, function calls, conditional statements and the like, and edges represent possible execution paths between those actions. Most nodes have a single outgoing edge representing the next operation in a sequence, while conditional nodes can have multiple outgoing edges corresponding to the different outcomes of the condition (e.g., TRUE and FALSE branches). Although such graphs can reveal the conditions under which a rule executes, in practice they often become extremely complex for real-world programs, particularly those implemented in large legacy computing systems or in enterprise applications. As a result, identifying the relevant execution conditions of a particular business rule through a full control flow graph is time-consuming to create, difficult to understand, and prone to error.

The control path generation system and associated method of the present invention provides for an improved approach for analyzing and presenting the conditions that lead to execution of business rules in a computing system. The control path generation system is configured to analyze the source code of one or more software applications or programs and generate a condition flow graph, which is a simplified representations of the execution paths that lead to the execution of business rules. The control path generation system includes a code analysis unit that can be configured to process the source code of a software program and produce code analysis data, which can include a structural representation of the code, such as a parse tree or an abstract syntax tree. The control path generation system can also include a control flow graphing unit for analyzing the code analysis data to generate a control flow graph setting forth the execution paths within the software application. The control flow graph can have a series nodes and edges connecting the nodes. The nodes can correspond to or represent a program element of the source code and each edge represents an execution path between the plurality of nodes. The nodes can also correspond to entry points of the program, conditions leading to execution of a business rule, business rules, and other types of programmatic information, such as methods, paragraphs, instructions or statements, method calls, and the like. The control path generation system can then employ a control process flow unit for identifying portions of program code that correspond to business rules, such as through analysis of computational logic, rule patterns, or other rule-identifying characteristics within the source code.

The control process flow unit employs techniques for deriving from the control flow graph a reduced or simplified version or representation of the control flow graph that includes only those nodes (e.g., program elements) that are relevant to understanding the conditions under which a business rule executes. In particular embodiments, the control process flow unit generates from the control flow graph a reduced condition flow graph that includes nodes from a selected set of node types, including for example entry point nodes, conditional nodes, and business rule nodes. condition flow graph captures the essential conditional logic leading to execution of the business rule while omitting nodes (e.g., program actions) that are not relevant to that determination.

In some implementations, the control process flow unit generates by the condition flow graph by iteratively removing nodes from the control flow graph that are not considered relevant to the analysis and hence are members of the selected set of node types, and then reducing or merging the edges entering and leaving the removed nodes so that the remaining nodes remain connected through a simplified path or graph structure. Through this node reduction process, the control flow graph is transformed into the conditional flow graph, which is a condensed representation of the control flow graph that preserves the logical relationships between entry points, conditional branches, business rules, and execution points. All statements that collectively implement the business rule may also be condensed into a single node representing the business rule as a whole, since the internal details of the business rule are known and need not be individually displayed when analyzing the conditions under which the rule executes.

The nodes retained in the condition flow graph can therefore include, for example, entry points into the program, conditional statements, such as IF statements or equivalent branching constructs, and nodes representing the execution of the business rule. The program actions that do not fall within the selected set of node types, such as intermediate computations, data assignments, value movements, statements, methods, calls, and the like, may be treated as non-essential for purposes of the conditional analysis and are removed during the graph reduction process performed by the control process flow unit.

By presenting the execution path leading to a business rule in a simplified and focused form, the control path generation system of the present invention enables users, such as analysts, developers, system maintainers, and the like, to more easily determine the precise conditions under which a business rule is executed. The resulting representation provides a concise and human-digestible visualization of rule execution logic that is particularly advantageous when analyzing large and complex software systems, including legacy enterprise applications in which business rules may be deeply embedded within extensive program code. Such simplified conditional path representations can significantly improve the efficiency, accuracy, and scalability of business rule analysis and documentation.

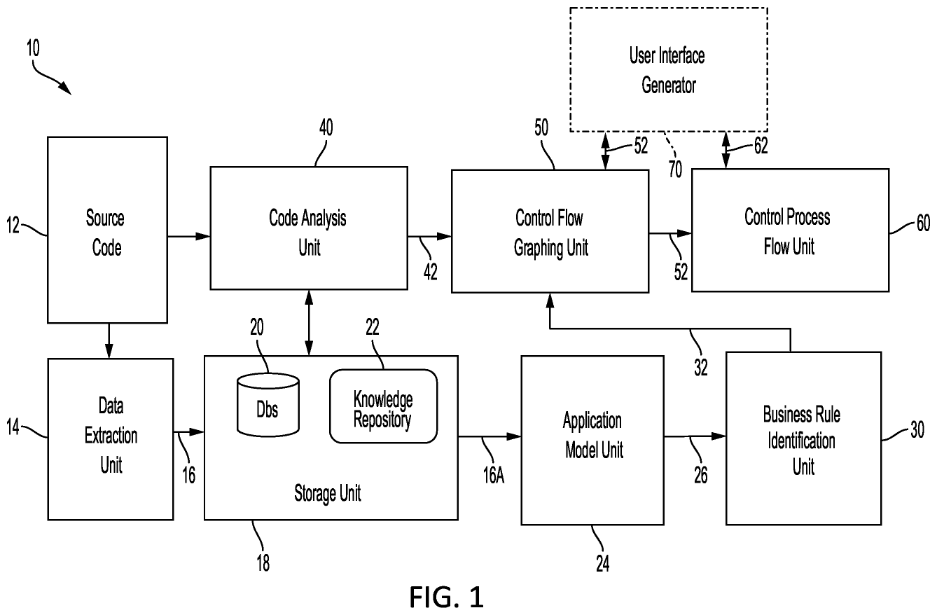

The control path generation system 10 of the present invention is shown for example in FIG. 1. The illustrated control path generation system 10 can employ one or more computing systems or one or more electronic devices that have one or more units, sub-units, modules, sub-modules, systems, or sub-systems that are configured to implement the functionality described herein. According to the present invention, the control path generation system 10 helps identify selected data, such as data or values associated with business rules, within a software application, generate a control flow graph, and then create a condition flow graph from the control flow graph by retaining nodes of a selected node type. The illustrated control path generation system 10 can include one or more data sources 12 for storing or supplying source code associated with one or more software applications or programs, such as for example program source code or database or screen descriptions. The illustrated control path generation system 10 can optionally include a data extraction unit 14, an application model unit 24, and a business rule identification unit 30 for identifying and storing business rules present and implemented within the source code. The data extraction unit 14 that can identify and extract selected types of information, such as programmatic elements, from the source code 12. According to one embodiment of the present invention, the data extraction unit 14 extracts the types of data that allows the system to subsequently identify, determine and represent business rules from the programmatic elements, as well as optionally the relationship between software artifacts (e.g., user interfaces, programs and data stores). For example, the data extraction unit 14 employs selected data extraction techniques to analyze the source code 12 of one or more software applications and to extract information, such as the programmatic elements, that is indicative or representative of business rules implemented within the software application. The programmatic elements can include, for example, data elements, statements, definitions, operations, code snippets, software artifacts, and relationships associated with the code. The data elements can include variables, parameters, constants, fields, attributes, database columns, or other data structures referenced by the code. The definitions can include declarations or structural constructs defining data structures, classes, methods, functions, or other software artifacts. The operations can include executable statements or expressions, such as conditional statements, comparison operations, assignment statements, calculations, loops, and function calls that embody validation, computation, or decision logic. The relationships can include dependencies or associations among the programmatic elements, including for example data flow relationships, derivation relationships, invocation relationships among programs or functions, and control-flow relationships within the source code 12. The programmatic elements provide information indicative of the business rules implemented within the software application. The data extraction unit 14 can then generate extracted data 16 that includes programmatic elements that are indicative or representative of the business rules.

Specifically, the programmatic elements can characterize how business rule logic is implemented in the source code 12. For example, the extracted programmatic elements can include program statements or code snippets that implement logic associated with business rules. Such statements may include conditional constructs (e.g., IF/THEN/ELSE statements, CASE statements, or other branching logic), iterative constructs (e.g., WHILE or FOR loops), computational expressions, assignment statements, comparison operations, or other sequences of executable statements that embody validation conditions, calculations, constraints, or decision logic. The extracted data 16 may also include data elements that participate in rule logic. These data elements may include variables, parameters, constants, fields, attributes, database columns, records, or other data structures referenced by the code snippets implementing the rule. In certain embodiments, relationships among data elements, such as dependencies or derivation relationships between input values and computed values, may also be identified and extracted. Additionally, the extracted data 16 can also include software artifacts that provide contextual information regarding where and how the business rule logic is implemented within the software application. The software or technical artifacts may include programs, modules, classes, methods, functions, services, stored procedures, database triggers, configuration elements, or other components of the application in which the relevant code snippets appear. Identifying the associated software artifacts allows the system to determine the locations within the application where particular rule logic is implemented. The extracted data 16 may further include operational and structural characteristics associated with the rule implementation, such as references to external services or databases, invocation relationships between programs or modules, input and output parameters, and the flow of data between components. Collectively, the extracted information enables the control path generation system 10 to detect business rules within the source code, characterize their logical structure, and identify multiple implementations of the same or similar business rules across different portions of the software application. The data extraction unit 14 can be implemented using known reverse engineering methods, such as for example by using software analysis tools, and preferably software static analysis tools. Examples of suitable software static analysis tools includes Apache Yetus, Axivion Bauhaus, Coverity, and the like.

The extracted data 16 can be optionally stored in a storage unit 18. The storage unit 18 can be any selected type of storage unit 18 as is known in the art. According to one practice, the storage unit 18 can include an optional database 20 for storing the extracted data 16. The database 20 can be any type of database and is preferably a relational database. The database 20 functions as a storage device for an optional knowledge repository 22, which can be implemented in connection with (e.g., on top of) the database 20, and which can be configured to also store the extracted data 16, which can include for example programmatic elements indicative or representative of the business rules (e.g., software artifacts, data elements and program statements). Consequently, the knowledge repository 22 can be used to store and make available for retrieval information associated with and about the software application and associated data. In particular, the knowledge repository 22 stores information about which statements appear in the application, which data elements are used in each statement, which data elements and which scripts appear on each user interface, which columns or fields appear in which data stores, which procedures are triggered by operations against tables, which programs call which programs, which programs communicate with which user interfaces, which programs access which data stores, and the like. The extracted data that is stored in the storage unit 18 can be later retrieved as stored extracted data 16A.

The control path generation system 10 can also include an optional application model unit 24 that employs an application model for storing all of the extracted data 16 or stored extracted data 16A, which includes the programmatic elements, such as software artifacts, entities, relationships and associated attributes. As such, the application model employed by the application model unit 24 can be employed as a convenient source of information about the software application being analyzed by the system 10. The entities can include programs, classes, statements, data elements, data stores such as tables, columns, or screens. The attributes can include for example any associated identifying information that can further specify the entity. The entities may be related through relationships such as statement read fields, program update tables, program calls, or program communications with for example a screen. The application model unit 24 can generate application model data 26 indicative or representative of the application model storing the business rule data that can be conveyed to other portions of the system for further processing. The application model data 26 can include information or data associated with the business rules with the software artifacts and the software application and associated programs.

In certain embodiments, the control path generation system 10 can be configured to operate on a collection or repository of previously identified business rules associated with a software application. Each business rule in the collection can represent a conceptual rule governing validation, computation, decision logic, or other business-related processing performed within the application. Each business rule can be associated with a unique identifier that distinguishes the rule from other rules stored in the repository. The identifier can be represented, for example, as a rule name, numeric identifier, label, or other reference that allows the rule to be uniquely referenced and managed within the system. In addition to the identifier, each business rule may be associated with one or more implementations representing locations within the source code where the logic corresponding to the rule is embodied. Each implementation may include information identifying the software artifact in which the rule logic appears, such as a source file, program, module, method, function, service, or other code component. The implementation record may further include positional information identifying the specific location of the code snippet that implements the rule within the corresponding source artifact. For example, the positional information may include the starting and ending line numbers, character offsets, or other markers indicating the precise region of the source code in which the rule implementation is located. In this manner, the system maintains a structured representation linking each business rule to the specific segments of source code that implement the rule within the software application.

In other embodiments, the illustrated control path generation system 10 includes an optional business rule identification unit 30 that can identify business rules in the source code 12. The business rules can be stored in an application model to form the application model data 26, the stored extracted data 16A, or the extracted data 16, and can form a list of the business rules so as to allow the user to identify instances of business rules within the software application. For example, and according to one embodiment, the business rule identification unit 30 can analyze the application model data 26 in the application model and identify selected patterns in the code, such as snippets of code, which can thus be associated with one or more business rules. That is, the business rule identification unit 30 identifies the business rules that are present in the applications model data. According to one embodiment, the operator or user can view, add or select the identified business rules thereto via a suitable user interface generated by the user interface generator 70, and then for each business rule specify if desired the snippets of code which embody the business rules. That is, the business rule identification unit 30 can create a business rule from each snippet of code or code snippet found by the code pattern search and then mark the code snippet as the embodiment of that business rule. The business rule identification unit 30 can generate business rule data 32 that includes the business rules of the source code 12.

The control path generation system 10 can also include a code analysis unit 40 for receiving and processing the source code 12. Specifically, the code analysis unit 40 can be configured to analyze the syntactic structure of the source code 12 and convert raw textual representation of the source code 12 into a structured, machine-interpretable form suitable for further analysis. In particular, the code analysis unit 40 can be configured to receive as input the source code 12 written in a programming language and apply a set of grammatical rules corresponding to that language to identify program constructs, such as statements, expressions, control structures, function or method definitions, and variable references. Through this process, the code analysis unit 40 can then determine whether the source code 12 conforms to the syntax of the programming language and organize the source 12 code into a hierarchical representation that reflects the logical structure of the program.

The code analysis unit 40 can then generate as an output code analysis data 42 that can be in essence a structured or hierarchical representation of the source code 12, such as a parse tree or, in other implementations, an abstract syntax tree (AST). The structured representation captures the syntactic relationships between elements of the source code in a selected form, such as a tree-like form, where nodes correspond to selected language constructs (e.g., conditional statements, loops, assignments, function calls, methods, instructions or statements, and the like) and edges represent hierarchical relationships between the language constructs. In some embodiments, the code analysis data 42 can additionally include or be associated with symbol tables, token streams, or intermediate or other type of representations that provide further semantic or contextual information about identifiers, data types, and scope. The structured representation output of the code analysis unit 40 and forming part of the code analysis data 42 enables downstream analysis processes, such as control flow graph generation, data flow analysis, and optionally identification of business rules, by providing a consistent and navigable representation of the program logic independent of the original textual format. The code analysis unit 40 can include one or more of a parser, a lexical analysis component, a syntax analysis component, a semantic analysis component, a control flow analysis component, a data flow analysis component, a call graph generation component, a rule identification component, and a graph transformation component, each configured to process the source code 12 or representations thereof to extract structural and behavioral information for use in generating simplified control paths and for generating the code analysis data 42.

The structured representation of the source code 12 generated by the code analysis unit 40 as the code analysis data 42 and the business rules forming part of the business rule data 32 can be provided as input to a control flow graphing unit 50. The illustrated control flow graphing unit 50 is configured to receive and process the code analysis data 42 and the business rule data 32. Specifically, the control flow graphing unit 50 can analyze the structural representation of the program within the code analysis data 42 and the business rules within the business rule data and generate a control flow graph that models the execution behavior of the program or software application. Specifically, the control flow graphing unit 50 can identify program elements within the structured representation corresponding to executable actions, including computations, assignments, data movements, function or method calls, instructions and statements, conditional constructs, and the like, as well as the business rules, and represent such elements and business rules as nodes within the control flow graph. The control flow graphing unit 50 further determines the possible execution paths between such nodes and represents such paths as directed edges, thereby capturing both sequential execution and branching behavior resulting from conditional statements, loops, and other control structures. In some embodiments, conditional constructs may be represented by nodes having multiple outgoing edges corresponding to alternative execution paths, such as TRUE and FALSE branches.

The control flow graphing unit 50 can be implemented using a variety of components or systems capable of deriving execution flow information from the structured representations in the code analysis data 42. For example, the control flow graphing unit 50 can include or be implemented as part of a compiler or compiler front-end configured to generate intermediate representations and associated control flow structures. In other embodiments, the control flow graphing unit 50 can include a static analysis engine configured to analyze source code or intermediate representations without executing the program. In further embodiments, the control flow graphing unit 50 can include one or more of a program analysis framework, an intermediate representation (IR) analysis component, or a graph construction module configured to traverse abstract syntax trees or similar representations and construct corresponding control flow graphs. Additionally, the control flow graphing unit 50 can be implemented using binary analysis tools, decompilation systems, or hybrid analysis systems that operate on compiled code to reconstruct control flow information. These and other variations are contemplated, provided that the control flow graphing unit 50 is capable of generating a representation of program execution flow suitable for subsequent processing, including reduction to a condition flow graph as described herein. The control flow graphing unit 50 can then generate control flow graphing data 52 indicative or representative of a control flow graph. Those of ordinary skill in the art will readily recognize that the code analysis data 42 and/or the control flow graphing unit 50 can be configured to identify the business rules in the source code, rather than via the data extraction unit 14 and the business rule identification unit 30. As such, the data extraction unit 14 and the business rule identification unit 30 can be in essence formed as sub-units of the code analysis unit 40 and/or the control flow graphing unit 50, or the extraction and identification of the business rules in the source code can be distributed between the code analysis unit 40 and the control flow graphing unit 50. The control flow graphing unit 50 can be configured to generate control flow graph data 52 that includes a control flow graph.

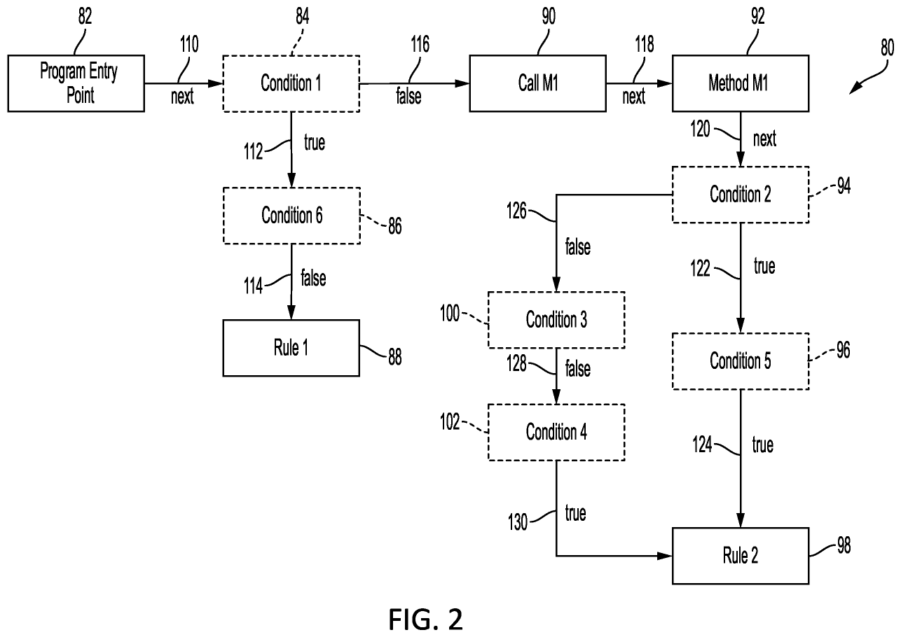

An example of a control flow graph generated by the control flow graphing unit 50 is shown, for example, in FIG. 2. The illustrated control flow graph 80 includes a series of nodes and directed edges that collectively represent execution behavior of a software application or program. The control flow graph 80 highlights decision points, branches, and, in some embodiments, iterative structures, such as loops within the software code. Each node of the control flow graph 80 can represent a basic block, which is generally defined as a sequence of instructions or program statements having an entry point and an exit point, with no internal branching except at the exit. In this manner, each node can include one or more programmatic elements, such as entry points, conditional statements, program calls, method invocations, business rule logic, instructions and statements, and the like. The edges of the control flow graph 80 represent control flow paths connecting the nodes and corresponding basic blocks, thereby indicating possible transitions in program execution. In particular, edges may be associated with the outcome of conditional evaluations (e.g., TRUE or FALSE branches of IF statements), and in the case of loops, edges may represent repeated execution paths until an exit condition is satisfied. Thus, the edges define the permissible sequences of execution through the nodes of the graph.

The illustrated control flow graph 80 is exemplary and depicts in a simplified form, for ease of explanation and understanding, selected nodes located along execution paths that lead to one or more business rules. As will be appreciated, a practical control flow graph can include many additional nodes and edges not shown in FIG. 2. The control flow graph 80 includes an execution entry point represented by node 82, which corresponds to a selected starting location within the application, program, method, or paragraph from which control flow analysis is initiated. The entry point node can be determined in a variety of ways, including for example by automatic identification based on program structure (e.g., a main routine or transaction entry), selection based on a call hierarchy, or manual designation by a user seeking to evaluate a particular portion of the program. In some embodiments, multiple entry points may be defined to analyze different execution contexts within the same application.

From the entry point node 82 in the control flow graph 80, execution proceeds along edge 110 to node 84. The node 84 can be representative of a conditional construct, such as for example an IF statement, that evaluates a first condition (e.g., condition 1) associated with a first business rule represented by the node 88. As a conditional node, the node 84 includes multiple outgoing edges corresponding to alternative execution paths based on the evaluation of the condition. For example, edge 112 may correspond to a TRUE evaluation of the condition, while edge 116 may correspond to a FALSE evaluation. When the condition at the node 84 evaluates to TRUE, then the control flow proceeds along edge 112 to the node 86, which represents an additional conditional construct (e.g., condition 6) associated with the first business rule. The node 86 can similarly include one or more outgoing edges representing further branching based on an evaluation of the condition. When the condition at the node 84 evaluates to FALSE, the control flow proceeds along edge 114 to the node 88, which represents execution of a first business rule (e.g., Rule 1). The node 88 can correspond to a consolidated node representing a set of program statements that collectively implement the business rule. In this manner, the control flow graph 80 illustrates how a particular combination of condition evaluations defines the execution context in which the business rule is invoked.

In some embodiments, additional execution paths can originate from the node 84. For example, the control flow graph 80 can include edge 116 extending from the node 84 to a node 90, representing another possible transition in the program logic. For example, the program logic can proceed from the node 84 along edge 116 to the node 90 when the condition at node 84 evaluates to FALSE. The node 90 can correspond to a program call (e.g., call M1) illustrating that the control flow graph 80 can capture inter-procedural execution behavior. From the node 90, execution proceeds along edge 118 to a node 92, which can represent entry into a called method or program unit (e.g., method M1). The node 92 can serve as an entry node for the invoked method and may be associated with a subgraph representing internal execution of that method.

Within the called method, execution proceeds to node 94, which represents a conditional construct (e.g., condition 2) associated with a second business rule (e.g., Rule 2) represented by node 98. As with other conditional nodes, the node 94 includes multiple outgoing edges corresponding to different evaluation outcomes. When the condition at node 94 evaluates to TRUE, execution proceeds along edge 122 to node 96, which represents a further conditional construct (e.g., condition 5) associated with the second business rule. If the condition at node 96 evaluates to TRUE, control flow proceeds to node 98, which represents execution of the second business rule.

If the condition at node 94 evaluates to FALSE, execution proceeds along edge 126 to a node 100, which represents an alternative conditional construct (e.g., condition 3) associated with the second business rule. The node 100 can include multiple outgoing edges corresponding to TRUE and FALSE evaluations. For example, if the condition at node 100 evaluates to FALSE (as shown), control flow proceeds to node 102, which represents yet another conditional construct (e.g., condition 4) associated with the second business rule. If the condition at node 102 evaluates to TRUE, execution proceeds along edge 130 to node 98, thereby reaching the second business rule through an alternative sequence of condition evaluations.

Accordingly, the control flow graph 80 illustrates how multiple distinct execution paths, defined by combinations of conditional outcomes, program calls, and method-level transitions, can converge on one or more business rule nodes. The directed edges 110-130 between the nodes 82-102 encode the permissible sequences of execution, while the conditional nodes define branching points that determine which paths are traversed during runtime. The structure of the control flow graph 80 enables identification and analysis of the specific conditions and execution contexts under which particular business rules are invoked, thereby providing a foundation for subsequent reduction and transformation of the control flow graph 80 into a simplified conditional flow graph representations as described herein.

As described herein, the business rule identification unit 30 can be configured to analyze the source code 12, or one or more representations thereof, to identify portions of the source code corresponding to business rules and to output identified business rules forming part of the business rule data 32. The identified business rules 32 can include references to locations within the source code 12, associated conditions, or metadata describing the rule logic. The control flow graphing unit 50 can be configured to receive the identified business rules 32 and incorporate them into the control flow graph 80, for example by representing each business rule as a corresponding node within the graph.

In other embodiments, the business rule identification may be performed by the code analysis unit 40, the control flow graphing unit 50, the business rule identification unit 30, or any combination thereof. Specifically, the identification of the business rules need not be done prior to or before generation of the control flow graph, such as by the business rule identification unit 30, but rather can be performed by the code analysis unit 40 and/or the control flow graphing unit 50. For example, during generation of a control flow graph from a structured representation of the source code, the control flow graphing unit 50 can be configured to further analyze the program elements to detect business rule logic and designate corresponding nodes within the control flow graph as business rule nodes. In such embodiments, the business rule identification and control flow graph generation may be performed in an integrated manner. In other embodiments, combinations of the foregoing approaches may be employed, such that the business rules are initially identified by the business rule identification unit 30 and subsequently refined, supplemented, or confirmed during control flow graph generation.

The control flow graphing unit 50 can be configured to generate control flow graphing data 52 that includes, for example, a control flow graph representing execution paths of the program or software application. The control flow graphing data 52 can be provided to a control process flow unit 60 configured to process and transform the control flow graph into a reduced representation thereof based on a selected set of node types, such as by emphasizing execution conditions associated with the business rules. According to one embodiment, the control process flow unit 60 can be configured to generate a conditional flow graph by selectively reducing the control flow graph generated by the control flow graphing unit 50 to include only selected nodes of interest, such as for example entry points, conditional nodes associated with the business rule, and nodes representing the business rules.

In some embodiments, the control process flow unit 60 can be configured to analyze the control flow graph to identify and classify nodes based on node type, such as entry nodes, condition nodes, method or call nodes, computation nodes, statements and instructions, business rule nodes, and the like. Based on this classification, the control process flow unit 60 can selectively eliminate nodes based on a set of node types that are not relevant to the determination of conditions leading to execution of the business rule, such as intermediate computation nodes, assignment nodes, method or call nodes, or other operational statement nodes that do not affect control flow decisions. In performing such reduction, the control process flow unit 60 can preserve the logical relationships between the remaining nodes by modifying the edges of the graph. For example, when a non-relevant node (e.g., a node not part of a predetermined set of node types) is removed from the control flow graph, the control process flow unit 60 can be configured to merge or reconnect incoming and outgoing edges associated with the removed node to form a direct edge (e.g., single edge) between adjacent remaining nodes. In this manner, a sequence of nodes in the original control flow graph may be collapsed or reduced into a single edge in the reduced representation, thereby preserving flow, reachability and execution ordering while eliminating unnecessary intermediate details. In some implementations, the control process flow unit 60 can iteratively apply such node elimination and edge merging operations until the resulting graph contains only the selected node types.

The resulting condition flow graph generated by the control process flow unit 60 thus represents a simplified execution path from one or more entry points of the program to one or more business rules, with intermediate paths defined solely by relevant conditional evaluations and statements. Each path within the condition flow graph may correspond to a sequence of condition nodes and associated outcomes (e.g., TRUE/FALSE branches) that need to be satisfied for the business rule to be executed. By removing extraneous nodes and consolidating edges, the control process flow unit 60 generates a reduced, human-readable representation that facilitates analysis of the specific conditions under which business rules are invoked and executed, while maintaining fidelity to the underlying execution logic of the original control flow graph.

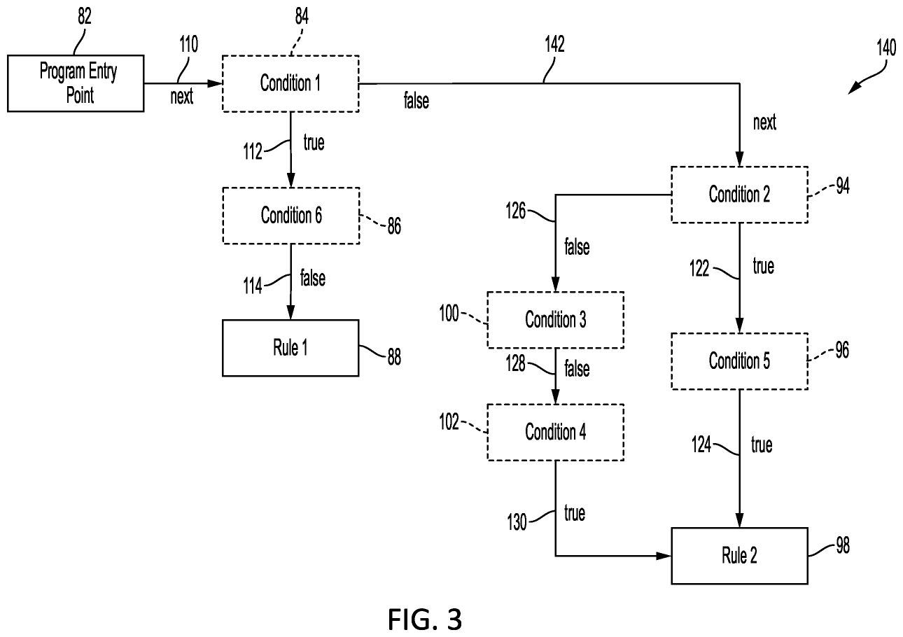

FIG. 3 illustrates an example of a condition flow graph 140 generated by the control process flow unit 60 based on the control flow graph 80 forming part of the control flow graphing data 52. In generating the condition flow graph 140, the control process flow unit 60 performs a reduction operation on the control flow graph 80 by removing selected types of nodes, such as for example nodes that are not relevant to evaluating the conditions under which one or more business rules are executed, and by correspondingly modifying the edges to preserve execution relationships between the remaining nodes. The node removal can be done automatically by the control process flow unit 60 based on the selected set of node types or automatically based on selected input from the user.

In the illustrated embodiment, the nodes 90 and 92 of the control flow graph 80, which represent a program call and a corresponding method entry, are removed from the control flow graph 80 by the control process flow unit 60 as part of the reduction process. In conjunction with the removal of these nodes, the control process flow unit 60 reduces, collapses or merges the associated edges 116, 118, and 120 into a single edge 142 that directly connects the adjacent remaining nodes. The edge reduction or consolidation preserves the logical structure and execution order between the nodes while eliminating intermediate nodes (e.g., program structure) that is not relevant to the conditional analysis associated with the business rules. More generally, when a node is removed, incoming and outgoing edges associated with that node can be reconnected to form one or more direct edges between the remaining nodes, thereby maintaining continuity of execution paths in the reduced graph.

As a result of the reduction process, the condition flow graph 140 includes or retains only the nodes corresponding to the selected set of node types (e.g., categories of nodes), including for example the entry point node, conditional nodes representing conditions associated with execution of the business rule, and nodes representing the business rules. All other node types, such as nodes corresponding to intermediate computations, data assignments, value movements, program calls, method invocations, or other operational statements or instructions, can be treated as non-essential for purposes of analyzing rule execution conditions and removed from the control flow graph 80.

The resulting condition flow graph 140 provides a simplified representation of execution paths that lead from an entry point node to one or more business rule nodes, where such paths are defined solely by relevant conditional evaluations. By eliminating non-essential nodes and consolidating edges, the control process flow unit 60 produces a reduced graph that is more compact and more readily interpretable, while still accurately reflecting the logical flow and conditions that govern execution of the business rules within the underlying program or software application. The control process flow unit 60 can then be configured to generate condition flow graph data 62 that includes the condition flow graph.

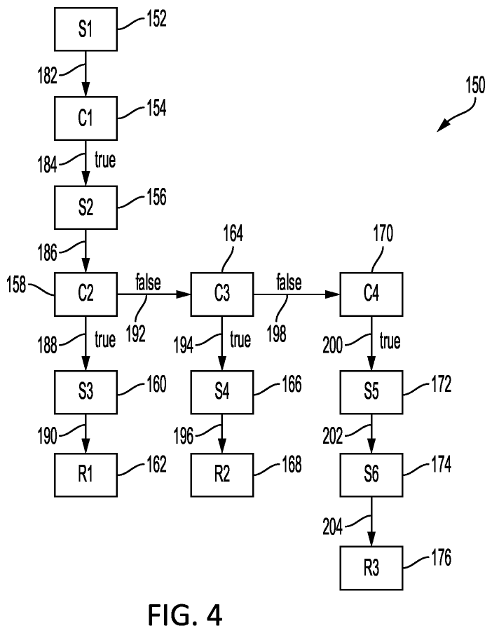

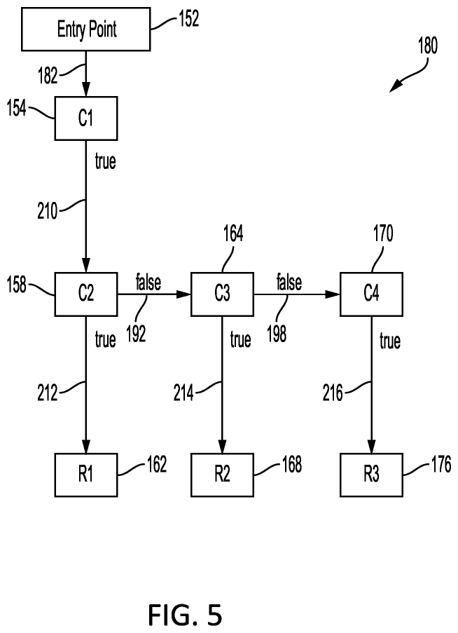

Another example of the generation of a control flow graph and the reduction of the control flow graph into a condition flow graph is shown for example in FIGS. 4 and 5. As shown, FIG. 4 shows an exemplary control flow graph 150 that includes a series of programmatic elements, such as entry points, conditional statements, program calls, programmatic statements, method invocations, business rule logic, and the like, represented as a series of nodes 152-176 and edges 182-204. As such, each node of the control flow graph 150 can encapsulate one or more of the programmatic elements and the edges represent control flow paths connecting the nodes and corresponding basic blocks, thereby indicating transitions in program execution. In particular, the edges can be associated with the outcome of conditional evaluations (e.g., TRUE or FALSE branches of IF statements). Thus, the edges define the permissible sequences of execution through the nodes of the control flow graph.

The illustrated control flow graph 150 depicts selected nodes along selected execution paths that lead to a series of business rules (e.g., rules R1, R2, and R3). As will be appreciated, a practical control flow graph can include many additional nodes and edges not shown in FIG. 4. The illustrated control flow graph 150 includes an execution entry point represented by node 152, which corresponds to a selected starting location within the software application or program and from which control flow analysis is initiated. In the illustrated example, the entry point node 152 is a statement (e.g., S1) and execution proceeds along edge 182 to node 154. The node 154 can be representative of a conditional statement or construct, such as an IF statement, that evaluates a first condition (e.g., C1) associated with a first business rule (e.g., R1) represented by node 162. As a conditional node, the node 154 can include multiple outgoing edges corresponding to alternative execution paths based on the evaluation of the condition. However, only the edge 184 associated with a TRUE evaluation is shown for purposes of simplicity and clarity. The execution of the control flow within the condition flow graph 150 can then proceed along edge 184 when the condition is TRUE to node 156, which corresponds to a second statement (e.g., S2). The control flow then passes along edge 186 to conditional node 158, which corresponds to a second condition (e.g., C2). The conditional node 158 can have multiple edges associated therewith corresponding to a TRUE or FALSE evaluation of the underlying condition. As such, the edge 188 corresponds to a TRUE evaluation of the condition of node 158 and the control flow passes along to node 160. The node 160 corresponds to a further programmatic statement (e.g., S3). The control flow then passes along edge 190 to node 162, which corresponds to the first business rule (e.g., R1).

In the illustrated control flow graph 150, at node 158, when the evaluation of the condition is FALSE, the control flow passes along edge 192 to a node 164. The node 164 can be a further conditional node corresponding to a third condition (e.g., C3). When the evaluation of the condition represented by node 164 is true, the control flow proceeds along edge 194 to node 166. The node 166 can be representative of a programmatic statement (e.g., S4). The control flow continues to proceed along edge 196 to the second business rule (e.g., R2) represented by node 166. Returning to node 164, if the evaluation at the node is FALSE<then the control flow proceeds along edge 196 to conditional node 170 representative of a fourth condition (e.g., C4). If the evaluation of the condition is TRUE, then the control flow proceeds along edge 200 to node 172, which is representative of another programmatic statement (e.g., S5). The control flow then proceeds along edge 202 to node 174, which is also representative of another programmatic statement (e.g., S6). The control flow then proceeds along edge 204 to the third business rule (e.g., R3) represented by node 176. In this manner, the control flow graph 150 illustrates how a particular combination of condition evaluations along multiple distinct execution paths, defined by combinations of conditional outcomes and statements, defines the execution context in which the business rules R1, R2, and R3 are invoked. The directed edges 182-204 between the nodes 152-176 encodes the permissible sequences of execution, while the conditional nodes define branching points that determine which paths are traversed during runtime. The control flow graph structure enables identification and analysis of the specific conditions and execution contexts under which particular business rules are invoked, thereby providing a foundation for subsequent reduction and transformation into a simplified conditional path as described herein.

FIG. 5 illustrates an example of a condition flow graph 180 generated by the control process flow unit 60 based on the control flow graph 150 forming part of the control flow graphing data 52. Like numbers indicate like parts. In generating the condition flow graph 180, the control process flow unit 60 performs a reduction operation on the input control flow graph 150 by selectively removing nodes not forming part of a set of selected node types, such as for example nodes that are not relevant to evaluating the conditions under which one or more business rules are executed, and by correspondingly modifying the edges associated with the removed nodes to preserve execution relationships between the remaining nodes.

In the illustrated embodiment, the non-condition and business rule nodes are removed from the control flow graph 150. Specifically, the statement nodes 156, 160, 166, 172, and 174 are removed from the control flow graph 150 to form the condition flow graph 180. When removed, the control process flow unit 60 merges or collapses the associated edges associated with the removed nodes. Specifically, the edges 184 and 186 are replaced with edge 210, the edges 188 and 190 are replaced with the edge 212, the edges 194 and 196 are replaced with the edge 214, and the edges 200, 202, and 204 are replaced with the edge 216. The edge consolidation preserves the logical structure and execution ordering between the nodes while eliminating intermediate program structure that is not relevant to the conditional analysis. As a result of the reduction process, the condition flow graph 180 retains only nodes corresponding to selected node categories of interest, including the entry point node 152, conditional nodes 154, 158, 162, 164, 168, 170, and 176 representing conditions associated with execution of the business rule, and nodes 162, 168, and 176 representing the business rules. All other node types are treated as non-essential for purposes of analyzing rule execution conditions and removed from the control flow graph 150.

The resulting condition flow graph 180 provides a simplified representation of execution paths that lead from an entry point 152 to one or more business rules (e.g., R1, R2, and R3), where such paths are defined solely by relevant conditional evaluations. By eliminating non-essential nodes and consolidating edges, the control process flow unit 60 produces a reduced graph that is more compact and more readily interpretable, while still accurately reflecting the logical conditions that govern execution of the business rules within the underlying program.

With reference again to FIG. 1, the control flow graphing unit 50 and the control process flow unit 60 can communicate with a user interface generator 70 configured to generate one or more user interfaces for presenting graphical representations of program execution to a user. In particular, the control flow graphing data 52 generated by the control flow graphing unit 50 and the condition flow graph data 62 generated by the control process flow unit 60 can be provided to the user interface generator 70 for processing and visualization in a selected user interface.

The user interface generator 70 can be configured to render the control flow graph (e.g., control flow graphs 80, 150) and/or the condition flow graph (e.g., condition flow graphs 140, 180) in a graphical format suitable for user viewing and interaction, such as node-link diagrams in which nodes and edges are visually depicted and arranged to illustrate execution paths. In some embodiments, the user interface generator 70 can apply one or more layout techniques to organize the nodes and edges in the graphs in a readable and hierarchical manner, for example, by arranging entry points, conditional nodes, and business rule nodes in a logical sequence that reflects execution flow.

In addition to visualization, the user interface generator 70 can be configured to support interactive features that enable the user to explore and analyze the generated graphs. For example, the user interface can enable a user to selectively display either the control flow graph or the condition flow graph, switch between different levels of abstraction, highlight specific execution paths, or focus on particular business rules. In some embodiments, nodes and edges may be selectable, enabling the user to view associated metadata, such as underlying code segments, condition expressions, or rule definitions. The user interface generator 70 may further support filtering operations to limit displayed information to selected node types (e.g., conditions or business rules) or to specific execution paths.

In further embodiments, the user interface generator 70 can also be configured to enable modification or annotation of the displayed graphs. For example, the user can optionally annotate nodes, define or adjust entry points, or refine identification of business rules, with such user inputs optionally being fed back into the system for further processing or regeneration of the graphs. Accordingly, the user interface generator 70 provides an interactive mechanism for visualizing, analyzing, and, in some cases, modifying the control flow graph and the condition flow graph, thereby facilitating improved understanding of the conditions under which business rules are executed within the software application.

It is to be understood that although the invention has been described herein in terms of particular embodiments. The foregoing embodiments are provided as illustrative only and do not limit or define the scope of the invention. Various other embodiments, including but not limited to those described herein are also within the scope of the claims. For example, elements, units, modules, engines, tools and components described herein may be further divided into additional subcomponents or joined together to form fewer components for performing the same functions.

Any of the functions disclosed herein may be implemented using means for performing those functions. Such means include, but are not limited to, any of the components or units disclosed herein, such as the electronic or computing device components described herein.

The techniques described above and below may be implemented, for example, in hardware, one or more computer programs tangibly stored on one or more computer-readable media, firmware, or any combination thereof. The techniques described above may be implemented in one or more computer programs executing on (or executable by) a programmable computer or electronic device having any combination of any number of the following: a processor, non-transitory memory, a storage medium readable and/or writable by the processor (including, for example, volatile and non-volatile memory and/or storage elements), an input device, an output device, and a display. Program code may be applied to input entered using the input device to perform the functions described and to generate output using the output device.

The terms computing device or system and/or electronic device as used herein can refer to any device that includes a processor and a non-transitory computer-readable memory capable of storing computer-readable instructions, and in which the processor is capable of executing the computer-readable instructions in the memory. The terms computer system and computing system refer herein to a system containing one or more computing or electronic devices.

Embodiments of the present invention include features which are only possible and/or feasible to implement with the use of one or more computers, computer processors, and/or other elements of a computer system. Such features are either impossible or impractical to implement mentally and/or manually. For example, embodiments of the present invention may operate on digital electronic processes which can only be created, stored, modified, processed, and transmitted by computing devices and other electronic devices. Such embodiments, therefore, address problems which are inherently computer-related and solve such problems using computer technology in ways which cannot be solved manually or mentally by humans.

Any claims herein which affirmatively require an electronic device having a processor, a memory, and storage, or similar computer-related elements, are intended to require such elements, and should not be interpreted as if such elements are not present in or required by such claims. Such claims are not intended, and should not be interpreted, to cover methods and/or systems which lack the recited computer-related elements. For example, any method claim herein which recites that the claimed method is performed by a computer, a processor, a memory, and/or similar computer-related element, is intended to, and should only be interpreted to, encompass methods which are performed by the recited computer-related element(s). Such a method claim should not be interpreted, for example, to encompass a method that is performed mentally or by hand (e.g., using pencil and paper). Similarly, any product or computer readable medium claim herein which recites that the claimed product includes a computer, a processor, a memory, and/or similar computer-related element, is intended to, and should only be interpreted to, encompass products which include the recited computer-related element(s). Such a product claim should not be interpreted, for example, to encompass a product that does not include the recited computer-related element(s).

Embodiments of the present invention solve one or more problems that are inherently rooted in computer technology. For example, embodiments of the present invention solve the problem of identifying and correlating duplicate instances of a business rule within a software application. There is no analog to this problem in the non-computer environment, nor is there an analog to the solutions disclosed herein in the non-computer environment.

Furthermore, embodiments of the present invention represent improvements to computer and communication technology itself. For example, the system 10 of the present can optionally employ a specially programmed or special purpose computer in an improved computer system, which may, for example, be implemented within a single computing device.

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive (read) programs and data from, and write (store) programs and data to, a non-transitory computer-readable storage medium such as an internal disk (not shown) or a removable disk. These elements can also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium. Embodiments of the invention may store such data in such data structure(s) and read such data from such data structure(s).

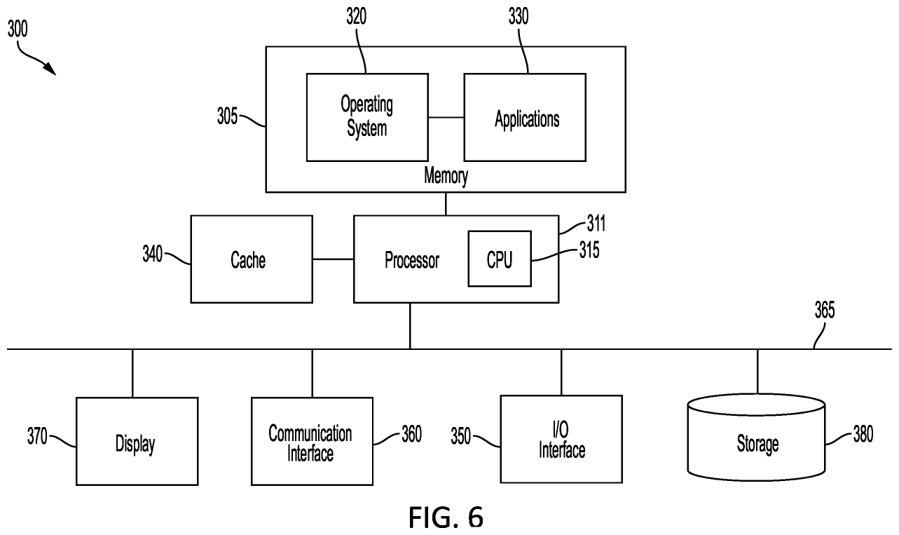

It should be appreciated that various concepts, systems and methods described above can be implemented in any number of ways, as the disclosed concepts are not limited to any particular manner of implementation or system configuration. Examples of specific implementations and applications are discussed below and shown in FIG. 6 primarily for illustrative purposes and for providing or describing the operating environment of the system of the present invention. The system 10 and/or any associated elements, modules, or units can employ one or more electronic or computing devices, such as one or more servers, clients, computers, laptops, smartphones and the like, that are networked together or which are arranged so as to effectively communicate with each other. The network can be any type or form of network. The devices can be on the same network or on different networks. In some embodiments, the network system may include multiple, logically-grouped servers. In one of these embodiments, the logical group of servers may be referred to as a server farm or a machine farm. In another of these embodiments, the servers may be geographically dispersed. The electronic devices can communicate through wired connections or through wireless connections. The clients can also be generally referred to as local machines, clients, client nodes, client machines, client computers, client devices, endpoints, or endpoint nodes. The servers can also be referred to herein as servers, server nodes, or remote machines. In some embodiments, a client has the capacity to function as both a client or client node seeking access to resources provided by a server or server node and as a server providing access to hosted resources for other clients. The clients can be any suitable electronic or computing device, including for example, a computer, a server, a smartphone, a smart electronic pad, a portable computer, and the like, such as the illustrated electronic or computing device 300. The system 10 or any associated units or components of the system 10 can employ one or more of the illustrated computing devices and can form a computing system. Further, the server may be a file server, application server, web server, proxy server, appliance, network appliance, gateway, gateway server, virtualization server, deployment server, SSL VPN server, or firewall, or any other suitable electronic or computing device, such as the electronic device 300. In one embodiment, the server may be referred to as a remote machine or a node. In another embodiment, a plurality of nodes may be in the path between any two communicating servers or clients. The system 10 which includes the data extraction unit 14, the storage unit 18, the application model unit 24, the rule identification unit 30, the code analysis unit 40, the control flow graphing unit 50, the control process flow unit 60, and the user interface generator 70 (elements of the system) can be stored on or implemented by one or more of the electronic devices described herein (e.g., clients or servers), and the hardware associated with the electronic devices, such as the processor or CPU and memory described below.

FIG. 6 is a high-level block diagram of an electronic or computing device 300 that can be used with the embodiments disclosed herein. Without limitation, the hardware, software, and techniques described herein can be implemented in digital electronic circuitry or in computer hardware that executes firmware, software, or combinations thereof. The implementation can include a computer program product (e.g., a non-transitory computer program tangibly embodied in a machine-readable storage device, for execution by, or to control the operation of, one or more data processing apparatuses, such as a programmable processor, one or more computers, one or more servers and the like).

The illustrated electronic device 300 can be any suitable electronic circuitry that includes a main memory unit 305 that is connected to a processor 311 having a CPU 315 and a cache unit 340 configured to store copies of the data from the most frequently used main memory 305. The electronic device can implement the process flow identification system 10 or one or more elements of the process flow identification system.

Further, the methods and procedures for carrying out the methods disclosed herein can be performed by one or more programmable processors executing a computer program to perform functions of the invention by operating on input data and generating output. Further, the methods and procedures disclosed herein can also be performed by, and the apparatus disclosed herein can be implemented as, special purpose logic circuitry, such as a FPGA (field programmable gate array) or an ASIC (application specific integrated circuit). Modules and units disclosed herein can also refer to portions of the computer program and/or the processor/special circuitry that implements that functionality.

The processor 311 is any logic circuitry that responds to, processes or manipulates instructions received from the main memory unit, and can be any suitable processor for execution of a computer program. For example, the processor 311 can be a general and/or special purpose microprocessor and/or a processor of a digital computer. The CPU 315 can be any suitable processing unit known in the art. For example, the CPU 315 can be a general and/or special purpose microprocessor, such as an application-specific instruction set processor, graphics processing unit, physics processing unit, digital signal processor, image processor, coprocessor, floating-point processor, network processor, and/or any other suitable processor that can be used in a digital computing circuitry. Alternatively or additionally, the processor can comprise at least one of a multi-core processor and a front-end processor. Generally, the processor 311 can be embodied in any suitable manner. For example, the processor 311 can be embodied as various processing means such as a microprocessor or other processing element, a coprocessor, a controller or various other computing or processing devices including integrated circuits such as, for example, an ASIC (application specific integrated circuit), an FPGA (field programmable gate array), a hardware accelerator, or the like. Additionally or alternatively, the processor 311 can be configured to execute instructions stored in the memory 305 or otherwise accessible to the processor 311. As such, whether configured by hardware or software methods, or by a combination thereof, the processor 311 can represent an entity (e.g., physically embodied in circuitry) capable of performing operations according to embodiments disclosed herein while configured accordingly. Thus, for example, when the processor 311 is embodied as an ASIC, FPGA or the like, the processor 311 can be specifically configured hardware for conducting the operations described herein. Alternatively, as another example, when the processor 311 is embodied as an executor of software instructions, the instructions can specifically configure the processor 311 to perform the operations described herein. In many embodiments, the central processing unit 530 is provided by a microprocessor unit, e.g.: those manufactured by Intel Corporation of Mountain View, Calif.; those manufactured by Motorola Corporation of Schaumburg, Ill.; the ARM processor and TEGRA system on a chip (SoC) manufactured by Nvidia of Santa Clara, Calif.; the POWER7 processor, those manufactured by International Business Machines of White Plains, N.Y.; or those manufactured by Advanced Micro Devices of Sunnyvale, Calif. The processor can be configured to receive and execute instructions received from the main memory 305.

The electronic device 300 applicable to the hardware of the present invention can be based on any of these processors, or any other processor capable of operating as described herein. The central processing unit 315 may utilize instruction level parallelism, thread level parallelism, different levels of cache, and multi-core processors. A multi-core processor may include two or more processing units on a single computing component. Examples of multi-core processors include the AMD PHENOM IIX2, INTEL CORE i5 and INTEL CORE i7.

The processor 311 and the CPU 315 can be configured to receive instructions and data from the main memory 305 (e.g., a read-only memory or a random access memory or both) and execute the instructions. The instructions and other data can be stored in the main memory 305. The processor 311 and the main memory 305 can be included in or supplemented by special purpose logic circuitry. The main memory unit 305 can include one or more memory chips capable of storing data and allowing any storage location to be directly accessed by the processor 311. The main memory unit 305 may be volatile and faster than other memory in the electronic device, or can dynamic random access memory (DRAM) or any variants, including static random access memory (SRAM), Burst SRAM or SynchBurst SRAM (BSRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM). In some embodiments, the main memory 305 may be non-volatile; e.g., non-volatile read access memory (NVRAM), flash memory non-volatile static RAM (nvSRAM), Ferroelectric RAM (FeRAM), Magnetoresistive RAM (MRAM), Phase-change memory (PRAM), conductive-bridging RAM (CBRAM), Silicon-Oxide-Nitride-Oxide-Silicon (SONOS), Resistive RAM (RRAM), Racetrack, Nano-RAM (NRAM), or Millipede memory. The main memory 305 can be based on any of the above described memory chips, or any other available memory chips capable of operating as described herein. In the embodiment shown in FIG. 4, the processor 311 communicates with main memory 305 via a system bus 365. The computer executable instructions of the present invention may be provided using any computer-readable media that is accessible by the computing or electronic device 300. Computer-readable media may include, for example, the computer memory or storage unit 305. The computer storage media may also include, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer readable storage media does not include communication media. Therefore, a computer storage or memory medium should not be interpreted to be a propagating signal per se or stated another transitory in nature. The propagated signals may be present in a computer storage media, but propagated signals per se are not examples of computer storage media, which is intended to be non-transitory. Although the computer memory or storage unit 305 is shown within the computing device 300 it will be appreciated that the storage may be distributed or located remotely and accessed via a network or other communication link.

The main memory 305 can comprise an operating system 320 that is configured to implement various operating system functions. For example, the operating system 320 can be responsible for controlling access to various devices, memory management, and/or implementing various functions of the asset management system disclosed herein. Generally, the operating system 320 can be any suitable system software that can manage computer hardware and software resources and provide common services for computer programs.

The main memory 305 can also hold application software 330. For example, the main memory 305 and application software 330 can include various computer executable instructions, application software, and data structures, such as computer executable instructions and data structures that implement various aspects of the embodiments described herein. For example, the main memory 305 and application software 330 can include computer executable instructions, application software, and data structures, such as computer executable instructions and data structures that implement various aspects of the content characterization systems disclosed herein, such as processing and capture of information. Generally, the functions performed by the content characterization systems disclosed herein can be implemented in digital electronic circuitry or in computer hardware that executes software, firmware, or combinations thereof. The implementation can be as a computer program product (e.g., a computer program tangibly embodied in a non-transitory machine-readable storage device) for execution by or to control the operation of a data processing apparatus (e.g., a computer, a programmable processor, or multiple computers). Generally, the program codes that can be used with the embodiments disclosed herein can be implemented and written in any form of programming language, including compiled or interpreted languages, and can be deployed in any form, including as a stand-alone program or as a component, module, subroutine, or other unit suitable for use in a computing environment. A computer program can be configured to be executed on a computer, or on multiple computers, at one site or distributed across multiple sites and interconnected by a communications network, such as the Internet.

The processor 311 can further be coupled to a database or data storage 380. The data storage 380 can be configured to store information and data relating to various functions and operations of the content characterization systems disclosed herein. For example, as detailed above, the data storage 380 can store information including but not limited to captured information, multimedia, processed information, and characterized content.

A wide variety of I/O devices may be present in or connected to the electronic device 300. For example, the electronic device can include a display 370, and as previously described, the visual application unit 28 or one or more other elements of the system 10 can include the display. The display 370 can be configured to display information and instructions received from the processor 311. Further, the display 370 can generally be any suitable display available in the art, for example a Liquid Crystal Display (LCD), a light emitting diode (LED) display, digital light processing (DLP) displays, liquid crystal on silicon (LCOS) displays, organic light-emitting diode (OLED) displays, active-matrix organic light-emitting diode (AMOLED) displays, liquid crystal laser displays, time-multiplexed optical shutter (TMOS) displays, or 3D displays, or electronic papers (e-ink) displays. Furthermore, the display 370 can be a smart and/or touch sensitive display that can receive instructions from a user and forwarded the received information to the processor 311. The input devices can also include user selection devices, such as keyboards, mice, trackpads, trackballs, touchpads, touch mice, multi-touch touchpads, touch mice and the like, as well as microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. The output devices can also include video displays, graphical displays, speakers, headphones, inkjet printers, laser printers, and 3D printers.

The electronic device 300 can also include an Input/Output (I/O) interface 350 that is configured to connect the processor 311 to various interfaces via an input/output (I/O) device interface 380. The device 300 can also include a communications interface 360 that is responsible for providing the circuitry 300 with a connection to a communications network (e.g., communications network 120). Transmission and reception of data and instructions can occur over the communications network.

We claim:

1. A system for generating a condition flow graph from a control flow graph having one or more business rules within a software application, the system comprising:
one or more processors; and
one or more non-transitory computer-readable media storing instructions that, when executed by the one or more processors, cause the system to:
receive source code of a software application;
generate, from the source code, a control flow graph having a plurality of nodes and a plurality of edges, wherein each of the plurality of nodes represents a program element of the source code and each edge of the plurality of edges represents an execution path between the plurality of nodes;
identify, within the control flow graph, one or more of the plurality of nodes corresponding to the business rules to form business rule nodes implemented within the source code;
generate the condition flow graph from the control flow graph by reducing the control flow graph, the reducing including:
retaining selected ones of the plurality of nodes belonging to a selected set of node types including entry point nodes, conditional nodes, and the business rule nodes;
removing one or more nodes from the control flow graph not belonging to the selected set of node types; and
for each removed node, merging incoming and outgoing edges associated with the removed node to form one or more direct edges between remaining nodes; and
display the condition flow graph to a user.

2. The system of claim 1, wherein the instructions, when executed by the processor, further cause the processor to:
analyze the source code using a code analysis unit to generate code analysis data having a structured representation of the source code; and
generate using a control flow graphing unit the control flow graph from the code analysis data.

3. The system of claim 2, wherein the structured representation comprises a parse tree or an abstract syntax tree.

4. The system of claim 3, wherein identifying the one or more of the plurality of nodes corresponding to the business rules comprises analyzing the source code to identify code snippets implementing business rule logic, and representing each identified business rule as business rule node within the control flow graph.

5. The system of claim 4, wherein the conditional nodes represent conditional constructs within the source code comprising at least one of an IF statement, a CASE statement, a WHILE loop, and a FOR loop, and wherein each conditional node includes multiple outgoing directed edges corresponding to alternative execution paths based on an evaluation outcome of the conditional construct.

6. The system of claim 4, wherein the nodes of the control flow graph include any combination of program call nodes representing calls to methods, functions, programs, instructions, statements, or paragraphs within the software application.

7. The system of claim 5, wherein the instructions, when processed by the processor, cause the processor to remove nodes not belonging to the selected set of node types until the condition flow graph includes only nodes of the selected set of node types.

8. The system of claim 7, wherein the condition flow graph represents execution paths from at least one entry point node to a plurality of business rule nodes, and wherein each execution path through the condition flow graph defines a sequence of conditional evaluations to be satisfied for a corresponding business rule to be executed.

9. The system of claim 8, wherein the instructions, when executed by the processor, further cause the processor to:
extract, from the source code, programmatic elements including at least one of data elements, statements, definitions, operations, code snippets, software artifacts, and relationships associated with the source code; and
store the extracted programmatic elements in a knowledge repository.

10. The system of claim 9, wherein the instructions further cause the processor to: generate, using an application model unit, an application model from the extracted programmatic elements, the application model including entities, relationships, and associated attributes corresponding to the software application.

11. A system for generating a condition flow graph from a control flow graph in a computing system, comprising
a data extraction unit for extracting source code from a software application,
a business rule identification unit for identifying one or more business rules in the source code,
a code analysis unit for processing the source code and to convert the source code into a structured representation of the source code to form code analysis data,
a control flow graphing unit for processing at least one of the code analysis data and the business rules to form the control flow graph having a plurality of nodes representing a program element of the source code and a plurality of edges representing an execution path between the plurality of nodes, wherein the plurality of nodes includes business rule nodes indicative of the business rules, conditional nodes indicative of the one or more conditions leading to execution of the business rule, and entry point nodes, the control flow graphing unit generating control flow graphing data that includes the control flow graph, and
a control process flow unit for receiving and processing the control flow graphing data and for generating from the control flow graph the condition flow graph, wherein the control process flow unit generates the condition flow graph by:
reducing the control flow graph by retaining selected ones of the plurality of nodes belonging to a selected set of node types including the entry point nodes, the conditional nodes, and the business rule nodes,
removing nodes from the control flow graph not belonging to the selected set of node types, and
for each removed node, merging incoming and outgoing edges associated with the removed node to form one or more direct edges between remaining nodes.

12. The system of claim 11, wherein the structured hierarchical representation comprises at least one of a parse tree and an abstract syntax tree.

13. The system of claim 12, wherein the business rule identification unit is configured to identify the business rules by analyzing the source code to identify code snippets implementing the business rule.

14. A computer-implemented method for generating a condition flow graph from a control flow graph having one or more business rules within a software application, the method comprising:
receiving, by one or more processors, source code of a software application;
generating, by the one or more processors, a control flow graph from the source code having a plurality of nodes and a plurality of edges, wherein each of the plurality of nodes represents a program element of the source code and each edge of the plurality of edges represents an execution path between the plurality of nodes;
identifying, by the one or more processors, within the control flow graph, one or more of the plurality of nodes corresponding to the business rules to form business rule nodes implemented within the source code;
generating, by the one or more processors, the condition flow graph from the control flow graph by reducing the control flow graph by:
retaining from the control flow graph selected ones of the plurality of nodes belonging to a selected set of node types including entry point nodes, conditional nodes, and the business rule nodes;
removing one or more nodes from the control flow graph not belonging to the selected set of node types; and
for each removed node, merging incoming and outgoing edges associated with the removed node to form one or more direct edges between remaining nodes; and
displaying the condition flow graph to a user.

15. The computer-implemented method of claim 14, further comprising:
analyzing the source code to generate code analysis data having a structured representation of the source code; and
generating the control flow graph from the code analysis data.

16. The computer-implemented method of claim 15, wherein the structured representation comprises a parse tree or an abstract syntax tree.

17. The computer-implemented method of claim 16, further comprising
identifying the one or more of the plurality of nodes corresponding to the business rules by analyzing the source code to identify code snippets implementing business rule logic, and
representing each identified business rule as business rule node within the control flow graph.

18. The computer-implemented method of claim 14, further comprising removing nodes not belonging to the selected set of node types until the condition flow graph includes only nodes of the selected set of node types.

19. The computer-implemented method of claim 18, further comprising, in the control flow graph, representing execution paths from at least one entry point node to a plurality of business rule nodes, and in the execution paths, defining a sequence of conditional evaluations to be satisfied for a corresponding business rule to be executed.

20. The computer-implemented method of claim 19, further comprising
extracting, from the source code, programmatic elements including at least one of data elements, statements, definitions, operations, code snippets, software artifacts, and relationships associated with the source code; and
storing the extracted programmatic elements in a knowledge repository.

21. The computer-implemented method of claim 20, further comprising generating, using an application model unit, an application model from the extracted programmatic elements, the application model including entities, relationships, and associated attributes corresponding to the software application.

22. A non-transitory computer-readable medium for storing instructions that, when executed by one or more processors, cause the one or more processors to perform operations, comprising:
receiving source code of a software application;
analyzing the source code to generate code analysis data comprising a structured representation of the source code;
generating, from the code analysis data, a control flow graph comprising a plurality of nodes and a plurality of edges, wherein the plurality of nodes represent program elements of the source code and the plurality of edges represent execution paths between the plurality of nodes;
identifying, within the control flow graph, business rule nodes from the plurality of nodes corresponding to business rules implemented in the source code;
generating a condition flow graph from the control flow graph by:
retaining nodes of the plurality of nodes belonging to a selected set of node types including at least entry point nodes, conditional nodes, and the business rule nodes;
removing from the control flow graph nodes not belonging to the selected set of node types; and
for each removed node, reconnecting incoming and outgoing edges of the removed node as one or more direct edges between adjacent remaining nodes; and
causing display of the condition flow graph.

23. The non-transitory computer-readable medium of claim 22, wherein the structured representation of the source code includes at least one of a parse tree and an abstract syntax tree.

24. The non-transitory computer-readable medium of claim 23, wherein the operations further comprise:
extracting, from the source code, programmatic elements comprising at least one of code snippets, data elements, conditional constructs, and relationships among program components; and
identifying the business rules based on patterns within the extracted programmatic elements.

25. The non-transitory computer-readable medium of claim 24, wherein the operations further comprise causing display of the control flow graph, and wherein a generated user interface enables a user to selectively switch between displaying the control flow graph and the condition flow graph.
